(19) United States
(12) Patent Application Publication
(10) Pub. No.: US 2007/0010150 A1
(43) Pub. Date: Jan. 11, 2007

(54) Textile materials exbiting enhanced soil-release properties and process for producing the same

(76) Inventors: Xinggao Fang, Duncan, SC (US); Michael E. Meadows, Lyman, SC (US)

Correspondence Address: Robert M. Lanning;Legal Department, M-495, 920 Milliken Road, PO Box 1926, Spartanburg, SC, 29304, US

(21) Appl. No.: 11/178,916

(22) Filed: Jul. 11, 2005

(51) Int. Cl. B32B 27/04; B32B 5/02; B32B 27/20

(52) U.S. Cl. 442/93; 442/59; 442/108; 442/152; 442/74; 442/75; 442/228; 442/94; 442/68

(57) ABSTRACT

The invention provides a treated textile material having a finish applied to at least a portion of the surface thereof. The finish comprises at least one particulate component which exhibits a positive surface charge when suspended in an aqueous medium. The invention further provides a process for producing a treated textile material comprising the steps of (a) providing a textile material having a surface, (b) providing a suspension comprising a medium and at least one particulate component, the particulate component exhibiting a positive surface charge when suspended in an aqueous medium, (c) applying the suspension to at least a portion of the surface of the textile material, and (d) heating the textile material to remove the medium from the textile material and produce a finish comprising the particulate component on the surface of the textile material.

### FIELD OF THE INVENTION

This invention pertains to textile materials exhibiting enhanced soil-release properties and a process for producing the same.

### BACKGROUND OF THE INVENTION

The soiling of textile materials (e.g., fabrics) has been, and continues to be, an area of concern for textile manufacturers and users. In an effort to address these concerns, several attempts have been made to develop finishes that can be applied to textile materials in order to increase the materials' ability to resist staining (e.g., by repelling staining agents) and/or release staining agents that may accumulate on the fiber structure of the textile material. For example, silicone finishes have been developed to increase a textile material's ability to resist staining by water-based staining agents. Also, fluorochemical finishes have been developed that impart both stain-repellant and soil-releasing properties to textile materials that have been treated with the same.

While the prior efforts to develop such finishes have met with varying degrees of success, a need still remains for finishes that impart enhanced soil-releasing properties to textile materials and which are relatively inexpensive and require minimal specialized processing to apply to the textile material.

The invention provides such a finish and a process for producing the same. These and other advantages of the invention, as well as additional inventive features, will be apparent from the description of the invention provided herein.

### BRIEF SUMMARY OF THE INVENTION

The invention provides a treated textile material comprising a textile material having a surface and a finish applied to at least a portion of the surface of the textile material, the finish comprising at least one particulate component which exhibits a positive surface charge when suspended in an aqueous medium.

The invention further provides a process for producing a treated textile material comprising the steps of (a) providing a textile material having a surface, (b) providing a suspension comprising a medium and at least one particulate component, the particulate component exhibiting a positive surface charge when suspended in an aqueous medium, (c) applying the suspension to at least a portion of the surface of the textile material, and (d) heating the textile material substantially dry the textile material and produce a finish comprising the particulate component on the surface of the textile material.

### DETAILED DESCRIPTION OF THE INVENTION

The invention provides a treated textile material comprising a textile material having a finish applied to at least a portion of the surface of the textile material. The finish comprises (or consists essentially of) at least one particulate component which exhibits a positive surface charge when suspended in an aqueous medium.

The treated textile material of the invention can comprise any suitable textile material. For example, the textile material can have a knit, woven, or non-woven construction and can comprise a yarn or yarns comprised of natural fibers, regenerated fibers, synthetic fibers, or combinations thereof. In one embodiment, the textile material is an apparel fabric, such as a knit, woven, or non-woven fabric suitable for use as clothing, in particular, socks. When the textile material is an apparel fabric, the fabric preferably is a knit fabric comprised of a yarn or plurality of yarns having a plurality of interlocking loops forming the fabric. Alternatively, the fabric can be a fleece fabric of either knit or woven construction, which fabric preferably has a pile (either loop or cut) or nap on at least one surface thereof.

The yarn from which the textile material is formed can comprise any suitable fiber or combination of fibers. For example, as noted above, the yarn can comprise natural fibers, regenerated fibers, synthetic fibers, or combinations thereof. Suitable fibers include, but are not limited to, cotton, wool, nylon, polyesters, acrylics, spandex, and aramids. In one embodiment, the yarn or plurality of yarns comprises a natural fiber or a combination of natural fibers. Preferably, the yarn or plurality of yarns comprise about 5 wt. % or more, more preferably about 10 wt. % or more (e.g., about 25 wt. % or more, or about 40 wt. % or more), most preferably about 50 wt. % or more, based on the weight of the fiber, of a natural fiber or a combination of natural fibers. Preferably, the natural fibers are selected from the group consisting of cotton, wool, and combinations thereof.

The finish applied to the surface of the textile material can comprise any suitable particulate component. Preferably, the particulate component exhibits a positive surface charge when it is suspended in an aqueous medium, such as an aqueous medium having a pH of about 4 to 8. As will be understood by those of ordinary skill in the art, the surface charge on the particulate components can be determined using many known techniques, such as measuring the zeta-potential exhibited by the particles when suspended in an aqueous medium. In certain embodiments, the particulate components preferably exhibit a positive zeta-potential of about 80 millivolts or less (e.g., about 2 to about 80 millivolts), more preferably about 20 to about 50 millivolts (e.g., about 25 to about 45 millivolts), when measured in an aqueous medium having a pH of about 2 to about 7.

Suitable particulate components include, but are not limited to, fumed alumina particles (e.g., CAB-O-SPERSE® PG 003 and CAB-O-SPERSE® PG 042 available from Cabot Corporation and VP W440 and VP W630 available from Degussa Corporation), colloidal alumina particles, hydrous aluminum oxide particles, and cationic silica particles, such as alumina-modified silica particles and silica particles that have been treated with one or more organosilane compounds (e.g., CAB-O-SPERSE® PG 022 available from Cabot Corporation). The particulate component can also be a particulate that is produced during the treatment of the textile material, such as a particulate produced by reacting an aminosilane with an alkoxysilane, such as methyltrimethoxysilane, glycidoxypropyltrimethoxysilane, n-octyltrimethoxysilane, or tetramethoxylsilane, in acidic conditions. Suitable particulate components can also include organic particulates (e.g., particulates composed of organic polymers or copolymers) and hybrid particulates comprising both organic and inorganic components, such as polysiloxane derivatives and polysilsequioxanes such as those sold under the tradenames Baygard SNF002 (available from LanXess) and Emulsion EPS 115 and EPS 1800 (both available from Wacker-Chemie). Preferably, the particulate component is selected from the group consisting of alumina, alumina-modified silica, and combinations thereof. More preferable, the particulate component is an alumina-modified silica (e.g., Ludox® CL or Ludox® CL-P available from GraceDavison).

The particulate component can be present in the finish in any suitable amount. Typically, the particulate component or combination of particulate components is present in the finish in an amount sufficient to improve the soil release properties of the textile material relative to similar textile materials to which the above-described surface finish has not been applied. Preferably, the particulate component is present in the finish in an amount of about 0.01 to about 10 wt. % (e.g., about 0.01 to about 5 wt. %), more preferably about 0.1 to about 2 wt. %, based on the weight of the textile material. As noted above, the finish can also comprise suitable combinations of two or more of the aforementioned particulate components. When such combinations are present in the finish, the particulate components can be present in any suitable ratio. For example, when the finish comprises two of the aforementioned particulate components, the ratio of the first particulate component to the second particulate component typically will be from about 1:10 to about 10:1, based on the total weight of the particulate components.

As will be understood by those of ordinary skill in the art, the aforementioned particulate components typically comprise a plurality of primary particles, which are the smallest individual particles present in the components. These primary particles can have any suitable diameter; however, the primary particles preferably are relatively small in size so as not to significantly affect the aesthetic qualities (e.g., appearance and feel) of the textile material. Thus, in certain embodiments, the primary particles of the particulate component preferably have a diameter of about 1 nm to about 1 μm, more preferably about 5 nm to about 50 nm. Those of ordinary skill in the art will also appreciate that the primary particles can be fused together to form aggregates, as in the case of fumed alumina or fumed silica, or can become weakly associated to form agglomerates. While the primary particles typically are relatively small in size, the agglomerates of the primary particles can be several hundred microns in size.

The finish applied to the surface of the textile material can contain other agents in addition to the aforementioned particulate component(s). For example, the finish can comprise an antimicrobial agent, an anti-odor agent, a softening agent (e.g., a silicone-based softener or an alkoxylated castor oil-based softener), a UV absorber, a lubricant, an antistatic agent, a wetting agent, or a flame retardant. However, in certain embodiments, the finish preferably is substantially free of a dye fixing agent. As utilized herein, the term “substantially free of a dye fixing agent” refers to a finish which does not contain a dye fixing agent in an amount sufficient to fix a dye or staining agent to the textile material. In other words, a finish which comprises a dye fixing agent in an amount sufficient to fix a dye or staining agent to the textile material is not “substantially free of a dye fixing agent.” In certain other embodiments, the finish preferably is substantially free of cationic amino compounds having a molecular weight of at least about 1000 and/or cationic amino compounds having a positive charge density of two milliequivalents per gram or greater.

These additional agents can be present in the finish in any suitable amount, but typically such an additional agent is present in the finish in an amount up to about 10 wt. %, based on the weight of the textile material. Preferably, the agent is present in the finish in an amount of about 0.1 wt. % to about 5 wt. %, based on the weight of the textile material. Such additional agents can be incorporated into the finish on the textile material using any suitable method. For example, the agent(s) can be incorporated into the finish before (e.g., during an initial dyeing process), simultaneous with, or after (e.g., in a rinse cycle) the particulate component is incorporated into the finish. Preferably, any additional agent(s) are incorporated into the finish at the same time as the particulate component(s) or during a final rinse of the textile material following the addition of the particulate component(s) to the finish.

The fabric of the invention can exhibit any suitable pH. Preferably, the fabric has a pH of about 7 or less (e.g., about 6 or less). As utilized herein, the reference to the pH of the fabric or the fabric pH refers to the pH of a water-extract obtained from the fabric. The pH of the fabric can be determined using any suitable technique. Preferably, the pH of the fabric is determined in accordance with AATCC Test Method 81-2001, entitled “pH of the Water-Extract from Wet Processed Textiles,” and is considered to be within the ranges recited herein when so determined.

The invention further provides a process for producing a treated textile material having a finish comprising a particulate component on the surface of the textile material. In particular, the method comprises the steps of (a) providing a textile material having a surface, (b) providing a suspension comprising a medium and at least one particulate component, the particulate component exhibiting a positive surface charge when suspended in an aqueous medium, (c) applying the suspension to at least a portion of the surface of the textile material, and (d) heating the textile material to remove the medium from the textile material and produce a finish comprising the particulate component on the surface of the textile material.

The textile materials suitable for treatment using the above-described method and the particulate component suitable for use in the method can be the same as those set forth above for the treated textile material of the invention.

As noted above, the method of the invention utilizes a suspension comprising (or consisting essentially of) a medium and at least one particulate component. As utilized herein, the term “suspension” refers to a system comprising particles dispersed in a medium, such as a liquid medium. The suspension can be colloidally stable (e.g., the particles are equal to or less than colloidal size) or colloidally unstable (e.g., the particles are greater than colloidal size). The term “suspension,” as utilized herein, is also intended to include systems that comprise an emulsion (e.g., a liquid dispersed as droplets in an immiscible liquid).

The medium can be any medium suitable for temporarily suspending or colloidally dispersing the particulate component(s) to be incorporated into the finish on the textile material. As will be appreciated by those of ordinary skill in the art, the medium should also be selected so as not to adversely affect the aesthetic qualities of the textile material. Preferably, the medium is an aqueous medium. The particulate component(s) suitable for use in the method can be the same as those set forth above for the treated textile material of the invention. In addition to the medium and the particulate component(s), the suspension can also comprise other components, such as the additional agents listed above in the discussion of the textile material of the invention or one or more agents, such as a dispersant or surfactant, to improve the medium's ability to suspend or disperse the particulate component(s).

The suspension utilized in the method of the invention can have any suitable pH. Preferably, the suspension has a pH of about 7 or less (e.g., about 6 or less).

The suspension can be applied to the textile material using any suitable technique. For example, the suspension can be applied to the textile material using pad and dry, foam, exhaust, spray, and garment wash. In the pad and dry method, the portion of the textile material that is to be treated can be immersed in the suspension containing the particulate component(s). The textile material is then passed through two nip rollers under pressure (e.g., at a pressure of about 280 kPa (40 psi)). In an exhaust method, the textile material is immersed in the suspension in a suitable container (e.g., a stainless steel container), and the container is then sealed and heated to a specified temperature for a period of time. The contents of the container are then cooled, and the excess suspension or medium is removed from the textile material using centrifugation. In another method, the suspension is applied to the textile material by immersing the textile material in a heated (e.g., to a temperature of about 60° C. (140° F.)), agitated bath containing the suspension. In this method, the textile material typically remains immersed in the suspension for a period of time sufficient for the desired amount of the particulate component to deposit on the surface of the textile material.

In any of the aforementioned methods, the suspension typically is applied to the textile material at a temperature up to about 140° C. (280° F.) (e.g., about 20° C. (68° F.) to about 140° C. (280° F.)), preferably about 35° C. (95° F.) to about 70° C. (158° F.), and more preferably about 37.8° C. (100° F.) to about 65.6° C. (150° F.). In certain embodiments, such as when the textile material or a portion thereof is immersed in the suspension, the textile material is immersed in the suspension for an amount of time sufficient for the particulate component to deposit on the surface of the textile material (e.g., about 30 minutes). The suspension typically is applied to the textile material at ambient pressure; however, in certain methods, the suspension can be applied to the textile material under pressure, for example, at a pressure up to about 414 kPa (60 psi).

Following the application of the suspension, the textile material can be rinsed prior to drying. The textile material can be rinsed using any suitable medium. Preferably, the textile material is rinsed in an aqueous medium.

After the suspension has been applied to the textile material and, if desired, the textile material has been rinsed, the textile material is then heated to remove substantially all of the remaining suspension medium or rinse medium from the textile. While not wishing to be bound to any particular theory, it is believed that heating the textile material also serves to set the finish on the textile material. The textile material can be heated to any suitable temperature; however, those of ordinary skill in the art will appreciate that the temperature should be selected so as not to negatively affect the textile material or any of the components of the finish. Preferably, the textile material is heated to a temperature of about 93.3° C. (200° F.) to about 232° C. (450° F.), more preferably about 93.3° C. (200° F.) to about 166° C. (330° F.).

The textile material according to the invention preferably exhibits improved soil release properties relative to similar textile materials to which the above-described finish have not been applied or which have not been treated in accordance with the inventive method. The improved soil release properties of the textile material according to the invention can be measured using any suitable technique. For example, the soil release properties of the textile material can be measured using AATCC Test Method 130-1982. In this test method, a stain is produced on a test specimen by forcing a given amount of a staining agent into the specimen using a specified weight. The stained specimen is then laundered in a prescribed manner, and any residual stain remaining on the specimen is rated on a scale from 5 to 1 (with higher numbers indicating less residual stain) by comparison with a standard stain release replica showing a graduated series of stains.

The following examples further illustrate the invention but, of course, should not be construed as in any way limiting its scope.

### EXAMPLE 1

This example demonstrates the soil release properties of a fabric according to the invention. Five similar samples (Samples 1A-1 E) of a white, cotton-rich knit fabric, weighing approximately 22 g each, were separately immersed in different aqueous media in a sealed stainless steel container. Sample 1A (comparative) was immersed in approximately 220 g of water, sample 1B (comparative) was immersed in an aqueous medium containing approximately 1.1 g of fumed silica particles (VP W7520s available from Degussa Corp.) and approximately 219 g of water, and sample 1C (comparative) was immersed in an aqueous medium containing approximately 1.1 g of colloidal silica particles (Ludox® AM available from Grace Davison) and approximately 218.6 g of water. Sample 1D (invention) was immersed in an aqueous medium containing 1.10 g of an alumina-modified colloidal silica (Ludox® CL-P available from Grace Davison) and 219 g of water, and sample 1E (invention) was immersed in an aqueous medium containing approximately 0.88 g of fumed alumina particles (VP W630 available from Degussa Corp.) and approximately 218.7 g of water.

After each fabric sample was added to a container containing the specified aqueous medium, the contents of the container were then heated from ambient temperature to a temperature of approximately 104° C. (220° F.) at a rate of approximately 2° C./minute. The contents of the container were then held at 104° C. (220° F.) for approximately 30 minutes, after which the contents were cooled to a temperature of approximately 43° C. (110° F.). After the aforementioned temperature was reached, the aqueous medium was drained from the container, and the fabric sample was rinsed in water. Excess water was then removed from the fabric sample using centrifugation, and the fabric sample was dried in an oven at a temperature of approximately 100° C. (212° F.) for approximately 30 minutes.

The resulting fabric samples were then subjected to soiling and soil release measurements using a modified version of AATCC Test Method 130-1982. In particular, the staining agent used in the measurements was a mixture of equal parts (by weight) of water and red clay (more specifically, a red clay indigenous to the northwestern regions of the State of South Carolina). After the staining agent was applied to each of the fabric samples in accordance with the aforementioned test method, the fabric samples were then washed in water at a temperature of approximately 40.6° C. (105° F.) using a commercially available household liquid laundry detergent (Tide® Liquid available from Procter & Gamble). After laundering, any residual clay stain remaining on the fabric samples was then rated on a scale ranging from 5 to 1 (with higher numbers indicating less residual stain) by comparison with a standard stain release replica showing a graduated series of stains. The results of these measurements, organized by stain class in accordance with the AATCC test method, are set forth in Table 1 below.

TABLE 1
Residual stain ratings for Samples 1A-1E organized by stain class.

| Stain | Sample | | | | |
|---|---|---|---|---|---|
| Class | 1A | Sample 1B | Sample 1C | Sample 1D | Sample 1E |
| 0/1 | 3.0 | 2.0 | 3.0 | 3.8 | 3.8 |
| 4/5 | 1.5 | 1.5 | 1.5 | 3.0 | 2.5 |

As demonstrated by the foregoing results, the fabric samples treated using an aqueous medium containing alumina-modified silica particles (Sample 1D) and fumed alumina particles (Sample 1E), each of which exhibit a positive surface charge when suspended in an aqueous medium, exhibited improved stain release relative to the fabric samples treated with fumed silica particles (Sample 1B) and colloidal silica particles (Sample 1C), each of which exhibits either a neutral or negative surface charge when suspended in an aqueous medium, or the fabric sample that was similarly treated with water alone (Sample 1A)

### EXAMPLE 2

This example demonstrates the soil release properties of a fabric according to the invention. Three similar samples (Samples 2A-2C) of a white, cotton-rich knit fabric, weighing approximately 22 g each, were separately immersed in different aqueous media. Sample 2A (comparative) was immersed in a medium containing water alone, sample 2B (invention) was immersed in medium containing approximately 4 wt. %, based on the total weight of the medium, of an alumina-modified colloidal silica (Ludox® CL-P available from Grace Davison), and sample 2C (invention) was immersed in a medium containing 4 wt. %, based on the total weight of the medium, of fumed alumina particles (VP W630 available from Degussa Corp.).

After the fabric samples were immersed in the aqueous media, the fabric samples were then passed through a pair of nip rollers at a pressure of approximately 280 kPa (40 psi) with a 60% wet pick-up. The fabric samples were then dried on a rack at a temperature of approximately 177° C. (350° F.).

The resulting fabric samples were then subjected to the modified soiling and soil release test method described in Example 1. The results of these measurements, organized by stain class in accordance with the AATCC test method, are set forth in Table 2 below.

TABLE 2
Residual stain ratings for Samples 2A-2C organized by stain class.

| Stain Class | Sample 2A | Sample 2B | Sample 2C |
|---|---|---|---|
| 0/1 | 3.0 | 4.3 | 4.8 |
| 4/5 | 1.5 | 3.8 | 3.8 |

As demonstrated by the foregoing results, the fabric samples treated using an aqueous medium containing alumina-modified silica particles (Sample 2B) and fumed alumina particles (Sample 2C), each of which exhibit a positive surface charge when suspended in an aqueous medium, exhibited improved stain release relative to the fabric sample that was similarly treated with water alone (Sample 2A).

### EXAMPLE 3

This example demonstrates the soil release properties of a fabric according to the invention. Three similar samples (Samples 3A-3C) of a white, cotton-rich knit fabric were separately immersed in different aqueous media in a sealed stainless steel container. Sample 3A (comparative) was immersed in medium containing approximately 220 g of water, Sample 3B (invention) was immersed in a medium containing 3 wt. %, based on the total weight of the medium, of an alumina-modified colloidal silica (Ludox® CL-P available from Grace Davison), and sample 3C (invention) was immersed in a medium containing 3 wt. %, based on the total weight of the medium, of an alumina-modified colloidal silica (Ludox® CL-P available from Grace Davison) and 2 wt. %, based on the total weight of the medium, of a silicone-based softener (Velvetol ES available from Eastman Chemical).

After each fabric sample was added to a container containing the specified aqueous medium, the fabric samples were treated in the same manner as the fabric sample in Example 1, with the following exceptions. The contents of the container were heated from ambient temperature to a temperature of approximately 60° C. (140° F.), which temperature was maintained for approximately 30 minutes. After the fabric samples had been drained and rinsed as set forth above, the samples were then dried at a temperature of about 120° C. (250° F.).

The resulting fabric samples were then subjected to the modified soiling and soil release test method described in Example 1. The results of these measurements, organized by stain class in accordance with the AATCC test method, are set forth in Table 3 below.

TABLE 3
Residual stain ratings for Samples 3A-3C organized by stain class.

| Stain Class | Sample 3A | Sample 3B | Sample 3C |
|---|---|---|---|
| 0/1 | 1.0 | 3.5 | 2.0 |
| 4/5 | 1.0 | 3.5 | 3.0 |

As demonstrated by the foregoing results, the fabric samples treated using an aqueous medium containing alumina-modified silica particles (Samples 3B and 3C), which exhibit a positive surface charge when suspended in an aqueous medium, exhibited improved stain release relative to the fabric sample that was similarly treated with water alone (Sample 3A). Furthermore, the results demonstrate that the addition of a softening agent to the aqueous medium used to treat the fabric sample can negatively impact the soil release properties of a fabric as compared to a similar fabric treated with the same particulate component in the absence of a softening agent.

### EXAMPLE 4

This example demonstrates the soil release properties of a fabric according to the invention. Three similar samples (Samples 4A-4C) of a white, cotton-rich knit fabric were separately immersed in different aqueous media. Sample 4A (comparative) was immersed in medium containing approximately 220 g of water, Sample 4B (invention) was immersed in a medium containing 3 wt. %, based on the total weight of the medium, of an alumina-modified colloidal silica (Ludox® CL-P available from Grace Davison), and sample 4C (invention) was immersed in a medium containing 3 wt. %, based on the total weight of the medium, of an alumina-modified colloidal silica (Ludox® CL-P available from Grace Davison) and 2 wt. %, based on the total weight of the medium, of a silicone-based softener (Wetsoft 150E available from Kelmar).

After the fabric samples were immersed in the aqueous media, the fabric samples were then passed through a pair of nip rollers at a pressure of approximately 280 kPa (40 psi) with a 60% wet pick-up. The fabric samples were then dried on a rack at a temperature of approximately 132° C. (270° F.).

The resulting fabric samples were then subjected to the modified soiling and soil release test method described in Example 1. The results of these measurements, organized by stain class in accordance with the AATCC test method, are set forth in Table 4 below.

TABLE 4
Residual stain ratings for Samples 4A-4C organized by stain class.

| Stain Class | Sample 4A | Sample 4B | Sample 4C |
|---|---|---|---|
| 0/1 | 1.5 | 4.0 | 4.5 |
| 4/5 | 1.0 | 3.5 | 4.0 |

As demonstrated by the foregoing results, the fabric samples treated using an aqueous medium containing alumina-modified silica particles (Samples 4B and 4C), which exhibit a positive surface charge when suspended in an aqueous medium, exhibited improved stain release relative to the fabric sample that was similarly treated with water alone (Sample 4A). Furthermore, the results demonstrate that the addition of a softening agent to the aqueous medium used to treat the fabric sample can improve the soil release properties of a fabric as compared to a similar fabric treated with the same particulate component in the absence of a softening agent.

### EXAMPLE 5

This example demonstrates the soil release properties of a fabric according to the invention. Two similar samples (Samples 5A and 5B) of a white, cotton-rich knit fabric were separately immersed in different aqueous media. Sample 5A was immersed in an aqueous medium containing water alone, and sample 5B was immersed in an aqueous medium containing 3 wt. %, based on the total weight of the medium, of an alumina-modified colloidal silica (Ludox® CL-P available from Grace Davison) and 0.5 wt. %, based on the total weight of the medium, of an alkoxylated castor oil-based softener (Syn Lube® 1632H available from Milliken Chemical).

After the fabric samples were immersed in the aqueous media, the fabric samples were then passed through a pair of nip rollers at a pressure of approximately 280 kPa (40 psi) with a 60% wet pick-up. The fabric samples were then dried on a rack at a temperature of approximately 132° C. (270° F.) for approximately 8 minutes.

The resulting fabric samples were then subjected to the modified soiling and soil release test method described in Example 1. The results of these measurements, organized by stain class in accordance with the AATCC test method, are set forth in Table 5 below.

TABLE 5
Residual stain ratings for Samples 5A and 5B organized by stain class.

| Stain Class | Sample 5A | Sample 5B |
|---|---|---|
| 0/1 | 1.0 | 5.0 |
| 4/5 | 1.0 | 3.5 |

As demonstrated by the foregoing results, the fabric sample treated using an aqueous medium containing alumina-modified silica particles (Sample 5B), which exhibit a positive surface charge when suspended in an aqueous medium, exhibited improved stain release relative to the fabric sample that was similarly treated with water alone (Sample 5A).

All references, including publications, patent applications, and patents, cited herein are hereby incorporated by reference to the same extent as if each reference were individually and specifically indicated to be incorporated by reference and were set forth in its entirety herein.

The use of the terms “a” and “an” and “the” and similar referents in the context of describing the invention (especially in the context of the following claims) are to be construed to cover both the singular and the plural, unless otherwise indicated herein or clearly contradicted by context. The terms “comprising,” “having,” “including,” and “containing” are to be construed as open-ended terms (i.e., meaning “including, but not limited to,”) unless otherwise noted. Recitation of ranges of values herein are merely intended to serve as a shorthand method of referring individually to each separate value falling within the range, unless otherwise indicated herein, and each separate value is incorporated into the specification as if it were individually recited herein. All methods described herein can be performed in any suitable order unless otherwise indicated herein or otherwise clearly contradicted by context. The use of any and all examples, or exemplary language (e.g., “such as”) provided herein, is intended merely to better illuminate the invention and does not pose a limitation on the scope of the invention unless otherwise claimed. No language in the specification should be construed as indicating any non-claimed element as essential to the practice of the invention.

Preferred embodiments of this invention are described herein, including the best mode known to the inventors for carrying out the invention. Variations of those preferred embodiments may become apparent to those of ordinary skill in the art upon reading the foregoing description. The inventors expect skilled artisans to employ such variations as appropriate, and the inventors intend for the invention to be practiced otherwise than as specifically described herein. Accordingly, this invention includes all modifications and equivalents of the subject matter recited in the claims appended hereto as permitted by applicable law. Moreover, any combination of the above-described elements in all possible variations thereof is encompassed by the invention unless otherwise indicated herein or otherwise clearly contradicted by context.

What is claimed is:

1. An apparel fabric comprising:
(a) a knit, woven, or non-woven textile material having a surface, the textile material being comprised of a yarn or plurality of yarns comprising a natural fiber or a combination of natural fibers, and
(b) a finish applied to at least a portion of the surface of the textile material, the finish comprising at least one particulate component which exhibits a positive surface charge when suspended in an aqueous medium,
wherein the fabric exhibits a pH of about 7 or less.

2. The apparel fabric of claim 1, wherein the particulate component is an inorganic particulate selected from the group consisting of alumina, alumina-modified silica, and combinations thereof.

3. The apparel fabric of claim 1, wherein the particulate component is present in the finish in an amount of about 0.01 to about 10 wt. % based on the weight of the textile material.

4. The apparel fabric of claim 3, wherein the particulate component is present in the finish in an amount of about 0.1 to about 2 wt. % based on the weight of the textile material.

5. The apparel fabric of claim 1, wherein the particulate component comprises primary particles, and the primary particles have a diameter of about 1 nm to about 1 μm.

6. The apparel fabric of claim 5, wherein the particulate component comprises primary particles, and the primary particles have a diameter of about 5 nm to about 50 nm.

7. The apparel fabric of claim 1, wherein the yarn comprises about 50 wt. % or more of a natural fiber selected from the group consisting of cotton, wool, and combinations thereof.

8. The apparel fabric of claim 1, wherein the textile material is a knit textile material provided in the form of a sock.

9. An apparel fabric comprising:
(a) a knit textile material having a surface, the knit textile material being comprised of a yarn or plurality of yarns comprising about 50 wt. % or more of a natural fiber selected from the group consisting of cotton, wool, and combinations thereof, and
(b) a finish applied to at least a portion of the surface of the textile material, the finish comprising about 0.01 to about 10 wt. %, based on the weight of the textile material, of particles of an alumina-modified silica,
wherein the fabric exhibits a pH of about 7 or less.

10. The apparel fabric of claim 9, wherein the particles of the alumina-modified silica comprise primary particles, and the primary particles have a diameter of about 5 nm to about 50 nm.

11. A process for treating an apparel fabric, the process comprising the steps of:
(a) providing an apparel fabric comprising a knit, woven, or non-woven textile material having a surface, the textile material being comprised of a yarn or plurality of yarns comprising a natural fiber or a combination of natural fibers,
(b) providing a suspension comprising a medium and at least one particulate component, the particulate component exhibiting a positive surface charge when suspended in an aqueous medium and the suspension exhibiting a pH of about 7 or less,
(c) applying the suspension to at least a portion of the surface of the textile material, and
(d) heating the textile material produced in step (c) to substantially dry the textile material and produce a finish comprising the particulate component on the surface of the textile material.

12. The process of claim 11, wherein the particulate component is an inorganic particulate component selected from the group consisting of alumina, alumina-modified silica, and combinations thereof.

13. The process of claim 11, wherein the particulate component is present in the finish in an amount of about 0.01 to about 10 wt. % based on the weight of the textile material.

14. The process of claim 13, wherein the particulate component is present in the finish in an amount of about 0.1 to about 2 wt. % based on the weight of the textile material.

15. The process of claim 11, wherein the particulate component comprises primary particles, and the primary particles have a diameter of about 1 nm to about 1 μm.

16. The process of claim 15, wherein the particulate component comprises primary particles, and the primary particles have a diameter of about 5 nm to about 50 nm.

17. The process of claim 11, wherein the yarn of the textile material comprises about 50 wt. % or more of a natural fiber selected from the group consisting of cotton, wool, and combinations thereof.

18. The process of claim 11, wherein the textile material is heated to a temperature of about 20° C. to about 140° C. during step (c).

19. The process of claim 18, wherein the textile material is heated to a temperature of about 35° C. to about 70° C. during step (c).

20. The process of claim 11, wherein the textile material is a knit textile material provided in the form of a sock.
